(19) United States
(12) Patent Application Publication
(10) Pub. No.: US 2006/0152818 A1
(43) Pub. Date: Jul. 13, 2006

(54) Adjustable lens system

(75) Inventors: Roger Shum, Los Altos Hills, CA (US); Biay-Cheng Hseih, Irvine, CA (US); Mickaiel H. Kamran, Laguna Hills, CA (US)

Correspondence Address: ESS TECHNOLOGY, INC;C/O HAYNES BEFFEL & WOLFELD LLP, P.O. BOX 366, HALF MOON BAY, CA, 94019, US

(73) Assignee: ESS Technology, Inc., Fremont, CA (US)

(21) Appl. No.: 11/292,315

(22) Filed: Dec. 1, 2005

Related U.S. Application Data
(60) Provisional application No. 60/643,184, filed on Jan. 12, 2005.

(51) Int. Cl. G02B 15/14

(52) U.S. Cl. 359/696

(57) ABSTRACT

An adjustable lens system comprises a housing, an adjustable lens assembly, comprising a lens element, mounted to the housing and placeable in optical states, and a MEMS based micro-motor. The MEMS based micro-motor is mounted to the housing and is operably coupled to the lens assembly for movement of at least a portion of the lens assembly to change the optical state of the lens assembly.

### CROSS-REFERENCE TO OTHER APPLICATIONS

This application claims the benefit of U.S. Provisional Patent Application No. 60/643,184 filed on 12 Jan. 2005, titled Miniature Lens Module With Auto-Focus And Zoom Function In Camera Phone.

### FEDERALLY SPONSORED RESEARCH OR DEVELOPMENT

None.

### BACKGROUND OF THE INVENTION

The present invention relates to adjustable lens systems. In particular, it relates to a compact form factor for auto-focusing and zoom lens systems that can be adapted for use in a camera phone.

The development of cellular telephones to include a camera, known as camera phones, has created an additional reason for reducing the size of the lens module of small portable cameras. Some conventional camera phones use a small form factor macro lens; however, the macro lens approach does not offer auto-focus/zoom functions. Other alternatives include a liquid lens approach, used by Varioptic of France and Philips Electronics of the Netherlands as auto-focus control, and a piezoelectric micro-motor approach, proposed by Origami of Cambridge, UK. However, some of these options often require large amounts of power to drive the actuator thus increasing the cost of the device. Also, piezoelectric material is difficult to manufacture at low cost.

References, which are incorporated by reference, and which may be useful in understanding this disclosure, include:

Tassen. A. A., et al, “Diffraction Grating Scanners Using Poly-silicon Micro-motors,” Proceedings of the IEEE Micro Electro Mechanical Systems, Conference, Amsterdam, Netherlands, Jan. 29-Feb-2, 1995, pp. 175-180.

Tai, T.-C and Muller, R. “IC-processed Micro-Motors: Design, Technology, and Testing,” Proceedings of the IEEE Workshop on Micro Electro Mechanical Systems, Salt Lake City, Utah, Feb. 20-22, 1989, pp. 1-6

Fan, L.-S, et al., “Integrated Multilayer High Aspect Ratio Milli-actuators,” Sensors and Actuators, vol. A48, no. 3, May 1995, pp. 221-227.

W. Tang, R. Miller, A. Desai, V. Temesvary, S. Wu, W. Hsieh, Y. C. Tai, and D. K. Miu, “Silicon Micro-machined Electromagnetic Micro-actuators for Rigid Disk Drives,” Proceedings, INTERMAG Conference, San Antonio, Tex., Apr. 18-21 1995.

See also the following patent references of SiWave, Inc. of Arcadia Calif.: U.S. Pat. Nos. 6,661,962; 6,661,955 and 6,785,031, and PCT publication number WO 20/016975.

### BRIEF SUMMARY OF THE INVENTION

The present invention recognizes that the small form factor required for an adjustable lens system capable of providing one or both of auto-focusing and zoom lens functions may be achieved by the use of a MEMS based micro-motor providing a linear stepping function to change the optical state of the lens assembly. In particular, placing a linear movement type of MEMS based micro-motor within a corner region, that is between the lens assembly and a corner of the lens assembly housing, helps to achieve this goal in an efficient, compact manner.

As used in this application, MEMS (Micro Electro-Mechanical Systems) refers to devices typically manufactured using processes similar to those used in semiconductor manufacturing and range in size from a micrometer or micron (one millionth of a meter) to a millimeter (one thousandth of a meter).

A first aspect of the invention is directed to an adjustable lens system comprising a housing, an adjustable lens assembly, comprising a lens element, mounted to the housing and placeable in optical states, and a MEMS based micro-motor. The MEMS based micro-motor is mounted to the housing and is operably coupled to the lens assembly for movement of at least a portion of the lens assembly to change the optical state of the lens assembly. In some embodiments the housing is a part of a camera phone. The optical states may comprise different focusing states and/or different focal length states. In some embodiments the housing may have corners regions, defined between the lens assembly and corners of the housing, with the micro-motor mounted within a corner region.

Various features and advantages of the invention will appear from the following description in which the preferred embodiments have been set forth in detail in conjunction with the accompanying drawings.

### BRIEF DESCRIPTION OF THE DRAWINGS

FIG. 1 is a simplified top view of a first embodiment of an adjustable lens system made according to the invention in which to MEMS based micro-motors are positioned at corner regions between the housing and the lens assembly for focusing the lens assembly;

FIG. 2 is a simplified cross-sectional view taken along line 2-2 of FIG. 1 illustrating the adjustable lens assembly positioned opposite an image sensor;

FIGS. 3, 4 and 5 are enlarged partial cross-sectional views of the structure of FIG. 2 with the lens assembly positioned at intermediate, distal and proximal focusing positions by the micro-motor;

FIG. 6 is similar to FIG. 1 and illustrates a second embodiment of an adjustable lens system in which MEMS based micro-motors are positioned at all for corner regions to provide both focusing and focal length (zoom or image size) functions;

FIGS. 7-9 are simplified cross-sectional views taken along line 7-7 of FIG. 6, similar to FIGS. 3-5, and illustrate a first, focusing micro-motor placing the lens assembly in different focusing states by placing the first and second lens elements in intermediate, distal and proximal positions with the third lens element remaining stationary; and

FIGS. 10-12 are simplified cross-sectional views taken along line 10-10 of FIG. 6, similar to FIGS. 7-9, and illustrate a second, focal length micro-motor placing the lens assembly in different focal length states by placing the third lens element in intermediate, distal and proximal positions with the first and second lens elements remaining stationary.

### DETAILED DESCRIPTION OF THE INVENTION

The following description of the invention will typically be with reference to specific structural embodiments and methods. It is to be understood that there is no intention to limit the invention to the specifically disclosed embodiments but that the invention may be practiced using other features, elements, methods and embodiments.

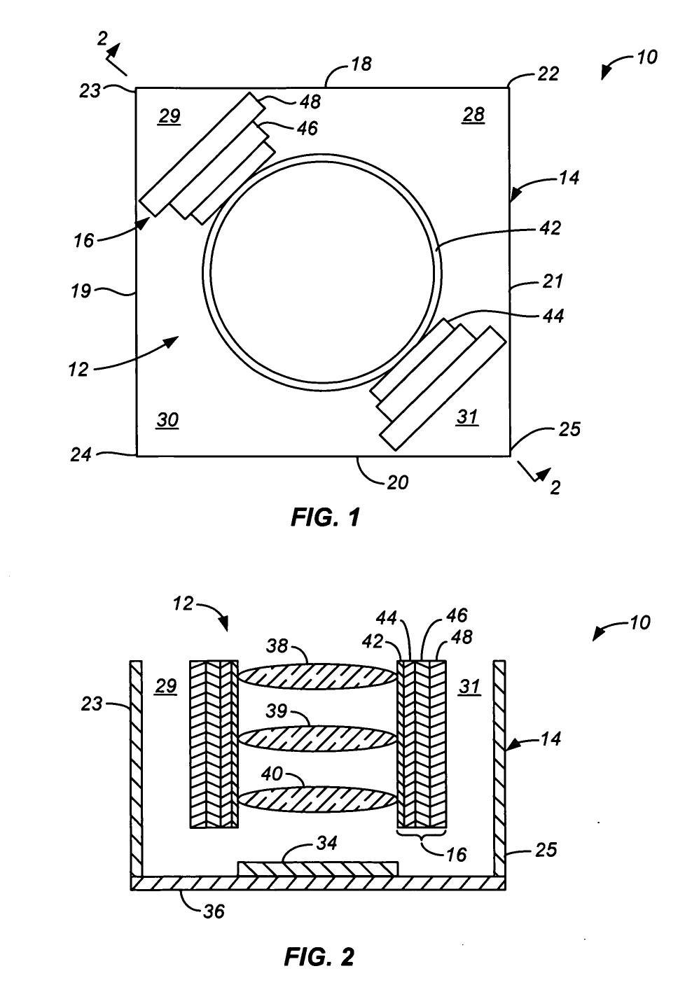

FIG. 1 is a simplified top view of a first embodiment of an adjustable lens system 10 made according to the invention. System 10 includes an adjustable lens assembly 12 positioned within a housing 14 by two MEMS based micro-motors 16. Housing 14 has four sidewalls 18-21 which meet at corners 22-25 and define four corner regions 28-31. Micro-motors 16 are positioned at corner regions 29 and 31 between corners 23 and 25 of housing 14 and lens assembly 12 for focusing the lens assembly relative to an image sensor 34, see FIG. 2, positioned at the base 36 of housing 14. Lens elements 38-40 are positioned within and are mounted to a generally cylindrical lens barrel 42. Micro-motors 16 are each attached to lens barrel 12 by a barrel attachment element 44.

Each micro-motor 16 includes an inner part 46 and an outer part 48. Outer part 48 is secured to sidewalls 18-21 and is thus stationary relative to housing 14. Micromotor 16 is a linear action micro-motor with inner part 46 movable along the axis of lens assembly 12 and relative to outer part 48. The stepper type movement of micro-motor 16 is in small enough increments to be effectively continuous. Therefore, actuation of micro-motor 16 causes inner part 46, as well as attachment element 44, lens barrel 42 and lens elements 38-42, to move axially relative to outer part 48 and to image sensor 34. This causes the optical state of lens assembly 16 to change.

Micro-motors 16 are a linear actuation type of actuator and may be of the type available for moving objects for moving objects from about 1˜5 mm with a moving force of about 1e-5 Newton-meter.

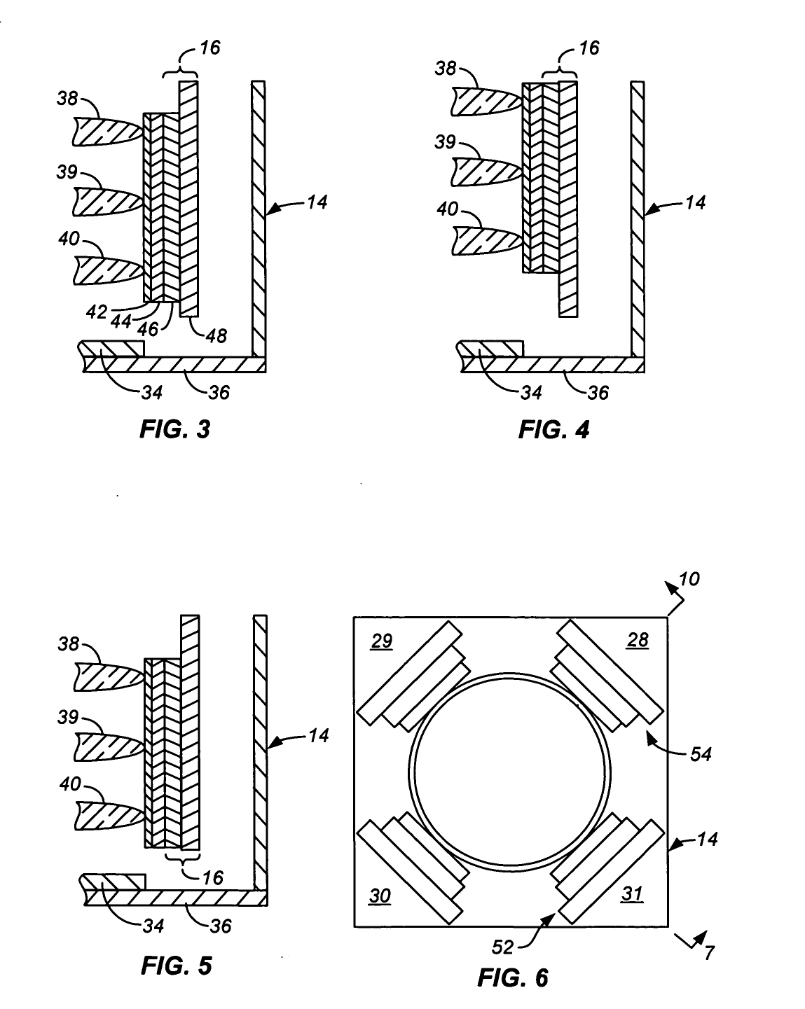

FIGS. 3, 4 and 5 are enlarged partial cross-sectional views of the structure of FIG. 2 with lens assembly 12 positioned by micro-motors 16 at intermediate, distal and proximal focusing positions relative to image sensor 34. In this embodiment the optical state is the focusing state of lens assembly 16. Therefore, actuating micro-motor 16 changes the focusing state or focus of lens assembly 12. In practice, the device, such as a camera phone, with which adjustable lens assembly 12 is used, may be constructed so that actuation of micro-motor 16 occurs automatically resulting in an auto-focus adjustable lens assembly 12.

FIG. 6 is similar to FIG. 1 and illustrates a second embodiment of an adjustable lens system 50 with like reference numerals referring to like elements. In this embodiment MEMS based micro-motors are positioned at all four corner regions 28-31 to provide both focusing and focal length (zoom or image size) functions. First, focusing type MEMS based micro-motors 52 are located at corner regions 29, 31 while second, focal length type MEMS based micro-motors 54 are located at corner regions 28, 30.

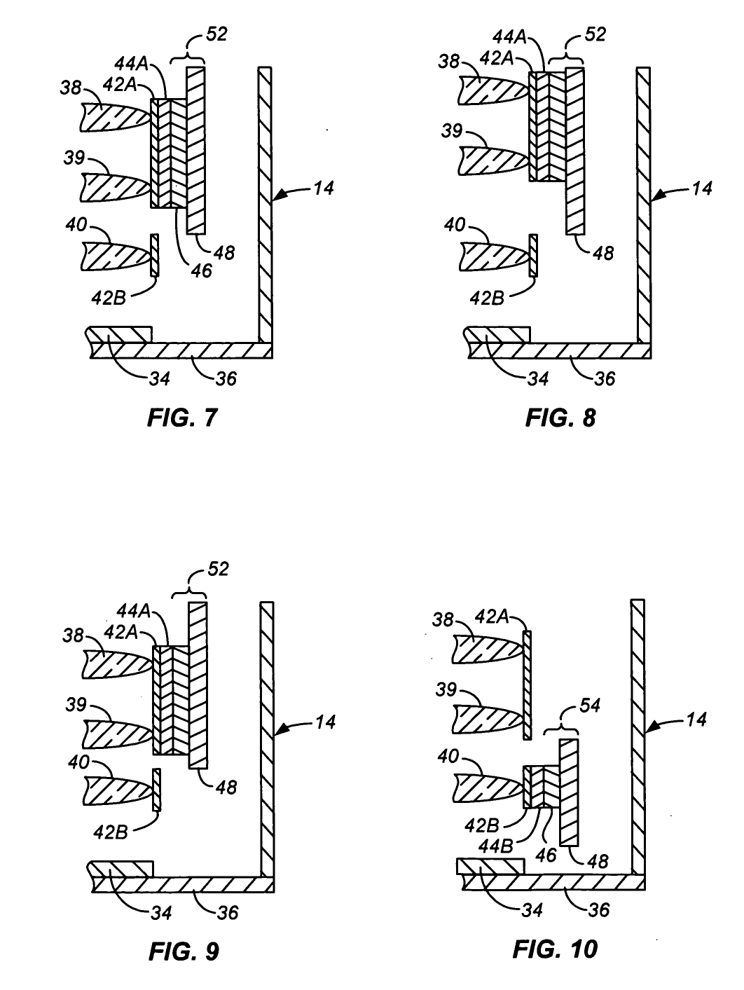

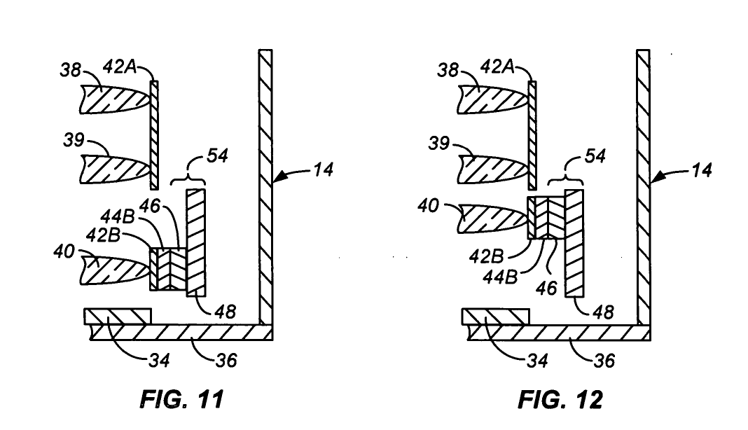

FIGS. 7-9 are enlarged, simplified cross-sectional views taken along line 7-7 of FIG. 6, similar to FIGS. 3-5, and illustrate first, focusing micro-motors 52 placing lens assembly in different focusing states by placing the first and second lens elements 38, 39 in intermediate, distal and proximal positions with third lens element 40, in this embodiment, remaining stationary. In this embodiment the lens barrel comprises a distal (relative to image sensor 34) lens barrel element 42A and a proximal lens barrel element 42B with first and second lens elements 38, 39 mounted within distal lens barrel element 42A and lens element 40 mounted within proximal lens barrel element 42B. The barrel attachment element comprises a distal barrel attachment element 44A and a proximal barrel attachment element 44B, proximal barrel attachment element 44B being shown in FIG. 10. The focusing of adjustable lens system 50 may therefore be changed by the actuation of micro-motors 52 causing the relative axial movement of inner and outer parts 46, 48 of the micro-motors.

As shown in FIG. 10, third lens element 40 is mounted within proximal lens barrel element 42B. Actuating second, focal length micro-motors 54 places lens assembly 12 in different focal length states by placing third lens element 40 in, for example, intermediate, distal and proximal positions relative to image sensor 34. Movement of third lens element 40 is thus independent of the movement of lens elements 38, 39 according to this embodiment. As with lens system 10, this adjustment can be made automatically or not.

Other modification and variation can be made to the disclosed embodiments without departing from the subject of the invention as defined in following claims. For example, in the above-described embodiments, lens assembly 12 includes first second and third lens elements 38, 39 and 40; other numbers of lens elements, or other optical elements, may also be used. While only a single focusing or focal length micro-motor may be used, force balance considerations suggest two or more micro-motors for each optical state to be changed is typically advised. In some embodiments it may be possible or desirable to use different micro-motors coupled to the same lens element or lens elements and move one or more of such lens elements during both focus and focal length changes. In some situations the housing may be cylindrical, or otherwise not have well-defined corners; in such cases MEMS based micro-motors may be configured to fit within the gap or gaps between the lens barrel, or other lens-element supporting structure, and the housing.

Any and all patents, patent applications and printed publications referred to above are incorporated by reference.

What is claimed is:

1. An adjustable lens system comprising:
a housing;
an adjustable lens assembly, comprising a lens element, mounted to the housing and placeable in optical states; and
a MEMS based micro-motor, mounted to the housing, operably coupled to the lens assembly for movement of at least a portion of the lens assembly to change the optical state of the lens assembly.

2. The system according to claim 1 wherein the housing is a part of a camera phone.

3. The system according to claim 1 wherein the optical states comprise different focusing states.

4. The system according to claim 3 wherein the micro-motor moves said at least a portion of the lens assembly to place the lens assembly in different focusing states.

5. The system according to claim 3 wherein the lens assembly comprises a plurality of lens elements and the micro-motor moves all of the lens elements to place the lens assembly in different focusing states.

6. The system according to claim 3 wherein the micro-motor moves said at least a portion of the lens assembly relative to the housing to place the lens assembly in different focusing states.

7. The system according to claim 1 wherein the optical states comprise different focal length states.

8. The system according to claim 7 wherein the micro-motor moves the lens element to place the lens assembly in different focal length states.

9. The system according to claim 8 wherein the lens assembly comprises a plurality of said lens elements and the micro-motor moves at least one of said plurality of lens elements to place the lens assembly in different focal length states.

10. The system according to claim 7 wherein the micro-motor moves the lens element relative to the housing to place the lens assembly in different focal length states.

11. The system according to claim 1 wherein:
the optical states comprise different focusing states and different focal length states;
the micro-motor comprises first and second micro-motors;
the first micro-motor moves at least a part of the lens assembly to place the lens assembly in different focusing states; and
the second micro-motor moves the lens element to place the lens assembly in different focal length states.

12. The system according to claim 11 further comprising a plurality of said first micro-motors and a plurality of said second micro-motors.

13. The system according to claim 1 wherein:
the housing comprises at least three sides connected to one another at corners, and further comprising:
corner regions defined between the lens assembly and the corners of the housing, and wherein:
the micro-motor is mounted within a corner region.

14. A zoom and focusing lens system for use with a camera phone comprising:
a housing comprising sides connected to one another at corners;
an adjustable lens assembly, comprising a lens element, mounted within the housing and placeable in different focusing states and different focal length states;
first, second, third and fourth corner regions defined between the lens assembly and corners of the housing, said first and third corner regions being on opposite sides of the lens assembly, said the second and fourth corner regions being on opposite sides of the lens assembly;
a first MEMS based micro-motor mounted within each of the first and third corner regions, operably coupled to at least a part of the lens assembly for movement of said at least a part of the lens assembly to change the focusing state of the adjustable lens assembly; and
a second MEMS based micro-motor mounted within each of the second and fourth corner regions, operably coupled to the lens element for movement of said lens element to change the focal length state of the adjustable lens assembly.

15. The system according to claim 14 wherein the adjustable lens assembly comprises a plurality of lens elements and the second MEMS based micro-motor is operably coupled to at least one of said lens elements.
